(19) United States
(12) Patent Application Publication
(10) Pub. No.: US 2026/0024065 A1
(43) Pub. Date: Jan. 22, 2026

(54) System and Method for Automated Charge Capture Using AI and Clinical Rule-Based Prediction

(71) Applicant: Fuse Oncology, Boone, NC (US)

(72) Inventors: Matthew Richard TERRY, Jonesboro, AR (US); Yusuf Fawzy ELNADY, Blacksburg, VA (US); David Bryan UNDERWOOD, Youngsville, NC (US); David Brian WIANT, Kernersville, NC (US); George James BAULER, II, Boone, NC (US); Lauren Kaylie MANCUSO, Durham, NC (US); Christel Johanna SMITH, Santa Barbara, CA (US); Benjamin Jeremiah SINTAY, Summerfield, NC (US)

(21) Appl. No.: 19/274,309

(22) Filed: Jul. 18, 2025

Related U.S. Application Data
(60) Provisional application No. 63/673,662, filed on Jul. 19, 2024.

(51) Int. Cl. G06Q 20/10; G06F 40/205; G06Q 20/14; G06Q 20/40

(52) U.S. Cl. CPC G06Q 20/102; G06F 40/205; G06Q 20/14; G06Q 20/401

(57) ABSTRACT

An automated system and method for medical billing charge capture is disclosed. The system integrates with electronic health records and specialty clinical systems to extract structured and unstructured clinical data, including documentation of patient care activities. A natural language processing engine analyzes unstructured text to identify relevant clinical attributes, which are combined with structured data and evaluated by a rules-based decision engine. The decision engine applies predefined billing rules and insight conditions to predict and validate appropriate billing codes. The system operates in a cloud-hosted, modular architecture, allowing secure, scalable deployment. Validated billing codes are stored with supporting documentation and transmitted to a billing system through secure protocols. A compliance dashboard provides real-time alerts, operational metrics, and audit reports. The system eliminates the need for manual clinician charge entry, improves compliance with payer requirements, reduces errors, and enhances efficiency by automating charge capture based on clinical documentation and predefined billing rules.

### CROSS-REFERENCE TO REPLATED APPLICATIONS

This application claims the benefit of U.S. Provisional Patent Application No. 63/673,662 filed Jul. 19, 2024, which is incorporated herein in its entirety.

### FIELD OF THE INVENTION

The present invention relates to medical billing and electronic health records. More specifically, it pertains to systems and methods for automating the capture of billable medical services using artificial intelligence (AI), natural language processing (NLP), and configurable rule-based engines to predict and assign billing codes without clinician input.

### BACKGROUND OF THE INVENTION

Healthcare providers currently rely on manual processes for medical billing, whereby clinicians must identify and enter billing codes for services rendered in order to get paid. This process is burdensome and error-prone due to the complexity of Current Procedural Terminology and Healthcare Common Procedure Coding System (CPT/HCPCS) coding. CPT codes, maintained by the American Medical Association, are primarily used to report physician and other healthcare professional services. They are a set of five-digit numeric codes used to report medical, surgical, and diagnostic services. Physicians, hospitals, and outpatient facilities use the CPT codes for billing and documentation. HCPCS is a two-level system. Level I is CPT, and Level II is a separate set of alphanumeric codes used for services HCPCS codes are used to report other medical services, supplies, and equipment not covered by CPT codes. These may include ambulance services, durable medical equipment, prosthetics, and certain drugs. Medicare, Medicaid, and other insurance programs require these codes to process claims.

It is an extremely daunting task finding the correct CPT code that matches a particular medical service because there are currently over 10,000 different CPT codes. On top of this are an additional 8,000 Level II HCPCS codes. Furthermore, CPT/HCPCS codes change annually as new codes are added and existing codes are revised or deleted. Further complicating matters is a general lack of formal training for clinicians in billing procedures. Errors in code selection or omissions often lead to lost revenue, denied claims, and compliance risks.

Furthermore, specialties, such as Radiation oncology, face multiple challenges, as services involve complex multi-step procedures that must be coded accurately and supported by specific documentation. Revenue cycle teams tasked with auditing often lack the specialty-specific knowledge required to provide accurate feedback, exacerbating inefficiencies and contributing to suboptimal compliance. This critical revenue function requires expert knowledge with steadfast attention to detail.

In addition, healthcare organizations often employ revenue cycle teams, who are responsible for managing the entire financial process of patient care, from initial contact and scheduling through final payment and reimbursement. Their primary goal is to ensure healthcare providers receive accurate and timely payment for the services they deliver. They are responsible for auditing clinical documentation and coding to ensure compliance with billing standards. They perform spot checks and provide recommendations to improve coding practices. Revenue cycle teams often lack specialized knowledge in radiation oncology, which can lead to inaccurate recommendations. They may not fully understand the clinical documentation and the specific coding requirements of the field. The lack of specialized knowledge among revenue cycle teams can result in compliance challenges. Their recommendations may not always be accurate, potentially leading to billing errors and compliance issues.

Unfortunately, the current practice for clinician review and charge selection for services rendered is reliant on costly, tedious, time-consuming and potentially error prone human labor.

### BRIEF SUMMARY OF THE INVENTION

Embodiments of the present invention provide a system and method for automatically identifying and capturing billing codes based on clinical documentation and activity data, without requiring clinician intervention, submission, oversight, or review. The system integrates with EHRs and a variety of databases, monitors structured and unstructured data, and applies NLP and a rules-based AI engine to determine and submit billing codes to generate invoices.

In various embodiments, the system includes components for data ingestion, NLP-based document analysis, configurable rules processing, charge validation, and automated submission. Insights and rules are used to predict the appropriate codes based on clinical activities, documentation, and other data. Additional features can include notifications to clinical staff of missing or inconsistent documentation. Audit and compliance modules can enhance overall usefulness by generating reports to ensure transparency and revenue integrity.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 depicts a schematic block diagram of an exemplary automated charge capture system configured to interface with clinical and billing systems to automatically generate and validate billing codes based on clinical data and documentation.

FIG. 2, a block diagram illustrates a cloud-hosted architecture for an automated charge capture system implemented in a cloud computing environment.

FIG. 3 illustrates a user interface screen of a charge capture system for configuring data mappings, insights, and rule triggers that drive automated charge capture decisions.

FIG. 4 illustrates a graphical user interface screen of the charge capture system showing an example of a configurable ruleset used to map detected clinical insights to billing charge codes.

FIG. 5 illustrates a flowchart depicting an exemplary process of automated charge capture performed by the disclosed system.

### DETAILED DESCRIPTION OF THE INVENTION

In one embodiment, the present invention comprises a cloud-deployed software system that automates the process of charge capture in a clinical setting, particularly in high-complexity specialties such as radiation oncology. The architecture is container-based, whereby individual microservices, referred to as pods, are hosted within a cloud environment like Microsoft Azure. Each pod operates as an independent application module capable of executing a specific function. These functions include charge capture, HPI generation, compliance review, audit report generation, and data exchange.

The application interfaces with both structured data sources and unstructured documents from various systems such as electronic health records and oncology information systems. Structured data includes event logs, imaging studies, and medication records, while unstructured data includes clinical notes, physician assessments, and documentation of treatments. Clinical activities and documentation are continuously monitored to detect relevant events.

Triggering mechanisms initiate processing when a specific document is approved or when certain clinical actions occur, such as initiation of a treatment or imaging session. These triggers are customized per site and configured in a mapping engine. Once triggered, a mapper component extracts raw data and processes it to derive clinically meaningful “insights.” An insight is an interpretation or condition derived from primary clinical data.

These insights are inputs to a rules based engine, which determines the appropriate billing code(s) based on predefined logical combinations of insight conditions. A rule might require that multiple insights are true while one or more others are false to trigger the prediction of a specific CPT code. These rule sets are maintained and updated by the software provider, ensuring accuracy, standardization, and secure proprietary protection. Typically, clients do not have access to view or modify these internal rules or mappings.

Once a charge code is predicted and validated, it can either be written back into the client's clinical system or transmitted directly to a billing system through secure formats like HL7 or FHIR. Validation occurs through automated checks to ensure that supporting documentation and appropriate timing are present for each predicted charge. Once submitted, the charge is stored with metadata linking it to the documentation and clinical data that justified it.

An optional feedback loop provides real-time alerts to clinicians or administrators when documentation is missing or inconsistent. This function helps improve data quality and provides transparency without requiring clinician intervention for routine charge capture. The system supports fully automated workflows but also allows hybrid configurations where manual oversight may be desired.

In addition to operational charge capture, the system features an audit and compliance module that compiles reports for administrative users. These reports may include summaries of missed revenue, flagged compliance risks, and audit logs for verification. Metrics may also be used for operational and business performance tracking.

Thereby, the automated charge capture system reduces the need for clinician training in billing and coding by removing them from the charge selection process. Instead of sending staff to seminars or conferences to understand revenue cycle compliance, clinics can rely on the built-in expertise of the platform. As a result, the system delivers measurable time and cost savings in both labor and education budgets.

In other embodiments, the system supports payer-verified rule sets, known as gold carding, which could allow bypassing prior authorization requirements if coding compliance is pre-validated. Additionally, the platform may detect potential underbilling and suggest higher-level codes when documentation supports them, thereby optimizing reimbursement while ensuring compliance.

The entire process is architected for transparency, auditability, and extensibility. Machine learning layers may further enhance predictive accuracy by analyzing historical data trends, performance metrics, and feedback loops.

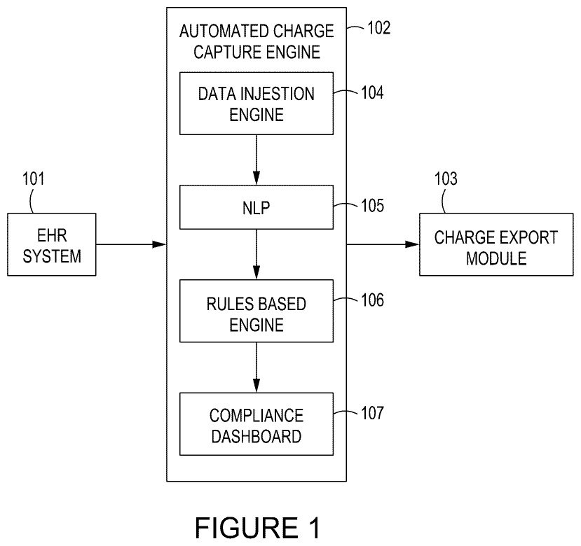

FIG. 1 depicts a schematic block diagram of an exemplary automated charge capture system configured to interface with clinical and billing systems to automatically generate and validate billing codes based on clinical data and documentation. The system comprises a plurality of functional components, including an EHR System 101, an automated charge capture engine 102, and a charge export module 103. The automated charge capture engine includes a data injection engine 104, a natural language processor 105, a rules based engine 106, and a compliance dashboard 107.

The EHR System 101 is an external electronic health record or oncology information system maintained by a healthcare provider. The EHR System 101 stores clinical data, including both structured data such as event logs, procedure records, and orders, and unstructured data such as clinician notes, reports, and correspondence. The EHR System transmits this clinical data to the automated charge capture system 101 through a secure interface. The EHR System may communicate with the automated charge capture engine 102 using standards-compliant messaging formats such as HL7 or FHIR, ensuring interoperability with existing clinical infrastructure.

The Data Ingestion Engine 104 is configured to receive structured and unstructured clinical data from the EHR System 101. This module includes parsers and connectors capable of interpreting various data formats including HL7, FHIR, and DICOM, and extracting relevant information into a normalized internal representation. The Data Ingestion Engine performs preprocessing such as data cleansing, deduplication, and time-sequencing to prepare the incoming clinical data for analysis. Structured data may include timestamps, procedure codes, and resource identifiers, while unstructured data may include narrative text, which is passed to downstream components for natural language processing.

The natural language processor (NLP) 105 receives unstructured text from clinical documentation, such as physician notes, nursing progress reports, pathology findings, and radiology summaries. This text often contains important details about the care provided but is written in free-form language that computers cannot directly interpret. The NLP 105 parses this text and applies algorithms to identify key information, such as procedures performed, diagnoses made, and treatment outcomes.

Once the relevant information is identified, the NLP 105 converts it into structured data elements, called insights, which the rules engine can use to determine the appropriate billing codes. For example, if a physician note states that a “patient underwent simulation for IMRT,” the NLP 105 extracts the fact that a simulation was performed and the modality was IMRT.

In another example, a nursing progress note may read, “Started radiation treatment today; 1 of 28 fractions delivered. Patient tolerated well.” The NLP block extracts the treatment start date, notes that one fraction was delivered, and recognizes the planned total of twenty-eight fractions. Similarly, if a pathology report states, “Biopsy confirms squamous cell carcinoma, positive margins,” the NLP block identifies the diagnosis is as squamous cell carcinoma and the margin status as positive.

By transforming free-text documentation into structured, machine-readable insights, the NLP block ensures that the system has the evidence it needs to justify billing codes. This step allows the rules based engine 106 to evaluate the documentation properly and ensures compliance with payer and regulatory requirements, while eliminating the need for manual review of narrative records

The natural language processing module, NLP 105, receives unstructured text from clinical documentation, such as physician notes, nursing progress reports, pathology findings, and radiology summaries. This text often contains important details about the care provided but is written in free-form language that computers cannot directly interpret. NLP 105 parses this text and applies algorithms to identify key information, such as procedures performed, diagnoses made, and treatment outcomes.

Once the relevant information is identified, NLP 105 converts it into structured data elements, called insights, which the rules-based engine can use to determine the appropriate billing codes. For example, if a physician note states that a “patient underwent simulation for IMRT with no evidence of metastatic disease,” NLP 105 extracts the fact that a simulation was performed, the modality was IMRT, and the clinical condition was absence of metastasis.

In another example, a nursing progress note may read, “Started radiation treatment today; 1 of 28 fractions delivered. Patient tolerated well.” NLP 105 extracts the treatment start date, notes that one fraction was delivered, and recognizes the planned total of twenty-eight fractions. Similarly, if a pathology report states, “Biopsy confirms squamous cell carcinoma, positive margins,” NLP 105 identifies the diagnosis as squamous cell carcinoma and the margin status as positive.

By transforming free-text documentation into structured, machine-readable insights, NLP 105 ensures that the system has the evidence it needs to justify billing codes. This step allows the rules-based engine 106 to evaluate the documentation properly and ensures compliance with payer and regulatory requirements, while eliminating the need for manual review of narrative records.

The rules-based engine 106 receives structured clinical data and insights generated by the NLP 105 and other system components. It evaluates this information against a predefined set of billing rules to determine whether the conditions for a specific billing code are satisfied. These rules are configured in advance to reflect payer guidelines, site-specific protocols, and regulatory requirements. The rules-based engine applies logical operations, such as “and,” “or,” and “not,” to test combinations of insights and structured data against the rules.

The rules-based engine 106 determines whether all necessary criteria are met for assigning a billing code. For example, one rule may require that a simulation procedure was performed and documented, the modality specified as IMRT, and there is no conflicting documentation suggesting an alternative treatment. If all these conditions are true, the rules-based engine predicts the billing code for an IMRT simulation.

In another example, a rule may state that if documentation shows that the patient started radiation therapy and at least one fraction was delivered on the treatment machine, the corresponding treatment billing code can be assigned. If the insights from the NLP block confirm that the treatment started on a given date, with the correct machine and fraction count, the rule is satisfied and the code is predicted.

Some rules may also include exclusion criteria. For instance, a rule for stereotactic body radiation therapy (SBRT) might require documentation of SBRT intent and delivery, but explicitly exclude cases where the documentation also indicates IMRT intent, as these are mutually exclusive codes. The rules-based engine 106 evaluates the presence and absence of insights to ensure the correct code is selected.

By applying these rules systematically, the rules based engine 106 ensures that billing codes are predicted accurately, based on both clinical activity and supporting documentation. The rules-based engine 106 eliminates the need for clinicians to manually interpret and apply complex billing guidelines, reducing errors and ensuring compliance.

The compliance dashboard 106 receives information from the rules based engine 106 and presents it in an accessible, actionable format for clinical and administrative users. The dashboard provides a real-time view of the charge capture system's operations, including alerts, predictions, and performance metrics. It serves as the interface through which users can monitor, validate, and, when necessary, intervene in the charge capture process.

The compliance dashboard 107 displays alerts when the system detects missing or inconsistent documentation that could jeopardize a claim. For example, if a simulation procedure was performed but the required documentation confirming treatment intent is absent, compliance dashboard 107 generates a notification for the user to review and correct the discrepancy before billing proceeds.

In another example, if NLP 105 and the rules-based engine 106 have predicted a billing code for a completed treatment, but the documented fraction count does not match the planned number of fractions, compliance dashboard 107 flags the inconsistency and displays the relevant records for resolution.

The dashboard also provides operational metrics and audit reports. These include summaries of captured charges, revenue trends, missed revenue opportunities, and adherence to payer rules over a specified period. For example, a user can generate a weekly report showing the number of predicted charges, the number of flagged exceptions, and the estimated revenue recovered by addressing these exceptions.

Compliance dashboard 107 enables authorized users to oversee the end-to-end charge capture process, ensuring that the system operates within compliance boundaries while maximizing revenue integrity. By centralizing this information in an intuitive interface, the dashboard reduces administrative burden and supports better decision-making.

The Charge Export Module 105 is configured to transmit validated billing codes to an external billing system or revenue cycle management platform. This module formats the billing codes and supporting metadata into a claim record compliant with payer and billing standards. The Charge Export Module interfaces with external systems through secure protocols, ensuring that billing codes predicted and validated by the automated charge capture system are delivered in a manner that is compatible with downstream financial processing.

The charge export module 103 is responsible for transmitting validated billing codes, along with their supporting documentation, to external billing systems or revenue cycle management platforms. After the NLP 105, the rules-based engine 106, and the compliance dashboard 107 have completed their respective analyses and verifications, the charge export module 103 packages the final billing information in the appropriate format and sends it securely to downstream systems.

The charge export module 103 formats the billing codes and associated metadata, such as patient identifiers, procedure dates, and supporting documentation references, into structured claim records that comply with payer and industry standards. For example, if a validated billing code is ready for submission, charge export module 103 may create an HL7 or FHIR-compliant claim object and transmit it over an encrypted channel to the client's billing department or third-party payer system.

In another example, if a healthcare provider prefers the charges to be recorded directly in their electronic health record (EHR) system, charge export module 103 writes the validated codes back into the provider's EHR database, ensuring seamless integration with the clinic's existing workflows. This enables the clinic to review or audit the charges within their familiar system, if desired.

The charge export module 103 also supports batching and scheduling capabilities. For instance, it can aggregate all validated charges over a given day or week and send them as a batch file to the billing system, reducing transaction overhead. Alternatively, it can operate in real-time, submitting each charge as soon as it is validated and approved by the compliance dashboard 106.

By automating the preparation, formatting, and secure transmission of validated billing data, the charge export module 103 eliminates the need for manual data entry and ensures that charges are delivered promptly, accurately, and in compliance with payer requirements. This improves operational efficiency and minimizes the risk of rejected or delayed claims.

This modular architecture enables the automated charge capture system to operate in a robust, configurable, and auditable manner. Each block performs a distinct and necessary technical function, and the interactions between the blocks ensure that billing codes are accurately and automatically derived from clinical documentation, thereby eliminating the need for manual charge entry and reducing the risk of human error.

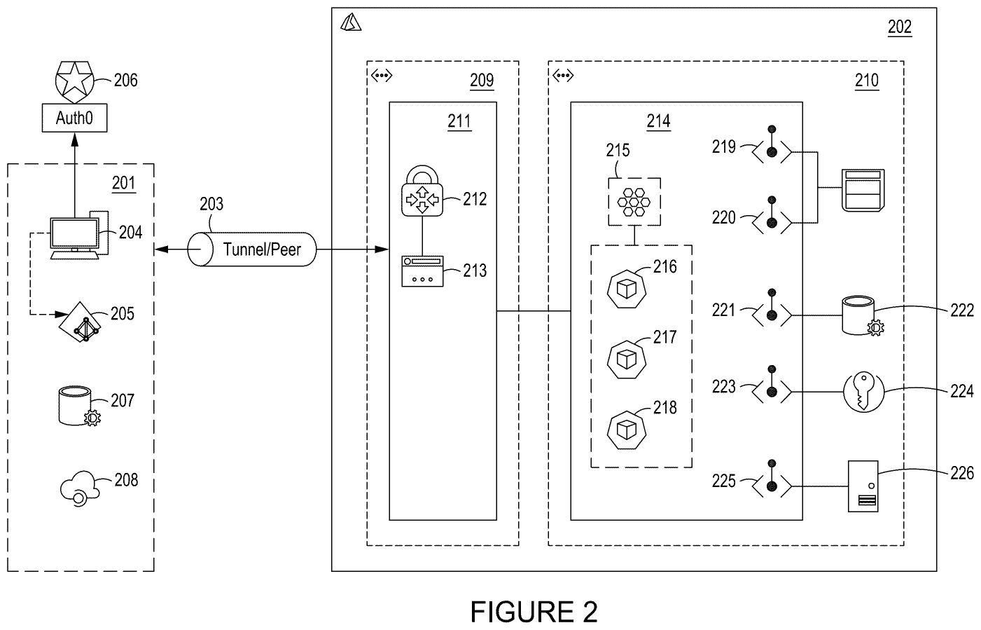

Referring to FIG. 2, a block diagram illustrates a cloud-hosted architecture for an automated charge capture system implemented in a cloud computing environment. The architecture comprises components within a customer network 201 and components within a cloud provider subscription 202, connected by a secure communication tunnel or peering connection 203.

Within the customer network 201, a client device 204, represented as a desktop computer, provides the user interface through which clinical staff interact with the charge capture system. The client device 204 is configured to authenticate users via an identity provider 205, such as Microsoft Active Directory or a similar service, and may also use an external authentication service 206, such as Auth0, to validate user credentials and enforce access policies. The client device 204 further communicates with on-premises systems, including an operational information system (OIS) database and services 207, which store clinical documentation, billing records, and electronic medical records, as well as an optional electronic health record (EHR) application programming interface (API) 208 that exposes structured clinical data. The customer network 201 communicates securely with the cloud provider subscription 202 through the tunnel or peering connection 203, depicted as an encrypted and authenticated link.

The cloud provider subscription 202, implemented for example as an Azure subscription, is divided into two virtual networks: a hub virtual network (vnet) 209 and an application virtual network (vnet) 210. The hub vnet 209 contains a gateway subnet 211 that hosts a virtual network gateway 212 responsible for managing secure connectivity between the customer network 201 and the cloud resources. The gateway subnet 211 also manages internal internet protocol (IP) addresses 213 for routing traffic securely within the cloud environment.

The application vnet 210 contains an application subnet 214 that hosts the primary charge capture system, implemented using Kubernetes services 215. The Kubernetes services 215 orchestrate a set of containerized workloads deployed as pods 216, 217, 218, where each pod may run microservices responsible for specific charge capture operations, such as clinical event ingestion, natural language processing of documentation, rules-based charge determination, charge validation, and charge export.

The application subnet 214 is configured with private endpoints to securely access required cloud services. An Azure blob storage private endpoint 219 provides access to storage for unstructured clinical documents and logs. An Azure file storage private endpoint 220 provides access to shared files needed for processing and auditing operations. An Azure SQL server private endpoint 221 connects to a signal web database 222 for storing structured data, including validated charge records and metadata. An Azure key vault private endpoint 223 connects to a signal key vault 224, which stores encryption keys, secrets, and configuration parameters for the system. An Azure Kubernetes service (k8s) API private endpoint 225 connects to a signal k8s API server 226, which manages the Kubernetes resources and cluster operations securely.

This architecture ensures that all communication between the customer network 201 and the cloud-hosted charge capture system remains private and encrypted, thereby protecting sensitive clinical and billing data. The design leverages private networking, managed identity services, and cloud-native components to deliver a secure, scalable, and highly available platform for automated medical billing charge capture.

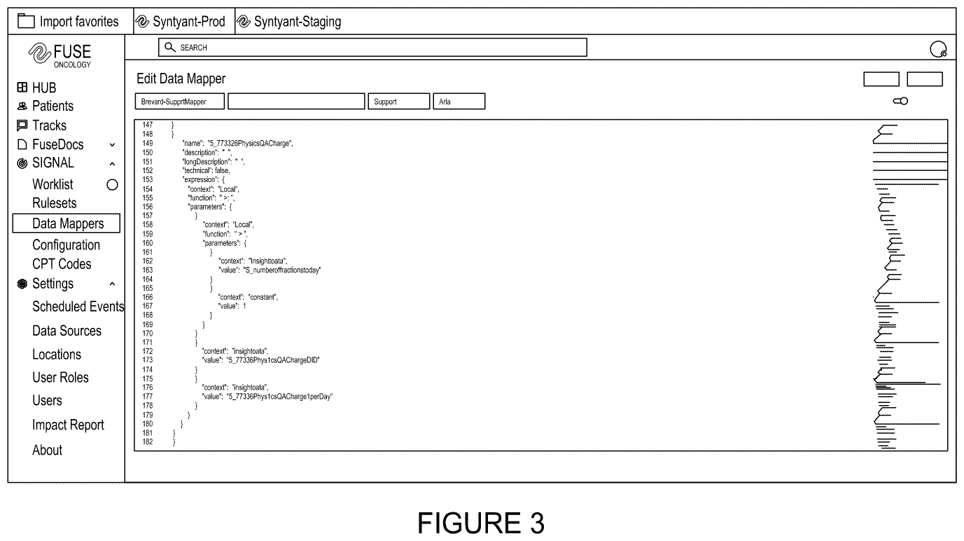

FIG. 3 illustrates a user interface screen of a charge capture system for configuring data mappings, insights, and rule triggers that drive automated charge capture decisions. The user interface is part of a cloud-hosted platform presented within a web browser and branded under the “Fuse Oncology” environment. The left-hand side of the screen displays a navigation menu with options such as HUB, Patients, Tracks, FusDocs, SIGNAL, Worklist, Rulesets, Data Mappers, Configuration, CPT Codes, Settings, Scheduled Events, Data Sources, Locations, User Roles, Users, and Impact Report. The highlighted selection in the navigation menu corresponds to the “Data Mappers” section, indicating that the current screen is used to edit and configure mappings that relate clinical insights to actionable charge rules.

The central portion shows a code editor where a JSON-based mapping configuration is presented. This configuration defines a series of rules and associated triggers that are applied based on detected insights from clinical data. The JSON structure contains fields such as “name,” “description,” “longDescription,” “technical,” “expression,” “function,” and a set of “parameters.” In the example shown, the mapping under edit has a name corresponding to a specific charge code and includes parameters that define the context, function, and values to be evaluated.

The “context” fields in the parameters specify different types of data sources or domains from which insights are extracted. For example, contexts labeled “Local,” “InsightData,” or “Constant” denote whether the value is derived from locally available data, dynamically computed insights, or fixed constant values, respectively. The “function” field defines the computational or logical operation to apply when evaluating the rule.

The insight data referenced within the configuration includes metrics such as the number of fractions today, specific identifiers, and charge-per-day indicators, which are derived from clinical documentation or real-time treatment events. These insight metrics are then used to trigger the application of appropriate charge codes when predetermined conditions are met. For example, if the number of fractions today exceeds a specified threshold, a specific physics quality assurance charge may be applied.

The system thus leverages the mappings configured in this interface to translate detected clinical insights into specific billing actions through the rules-based engine. The mapping acts as an intermediate layer that defines how insights, extracted from clinical workflows, documentation, or treatment sessions, are associated with specific charge codes and the criteria under which these codes are triggered and recorded.

This configuration mechanism enables administrators or clinical billing specialists to flexibly define, update, and test rules that reflect organizational policies and payer requirements, without modifying the core software. The editor interface includes features such as a validity checker (indicated as “VALID” in the figure), a code editor toggle, and buttons to save or run tests on the mapping.

Thereby, FIG. 3 demonstrates how the system integrates insight generation and rule-based decision-making by allowing users to author mappings that connect real-time or historical clinical insights to billing triggers, thereby automating charge capture processes based on observable and validated clinical events.

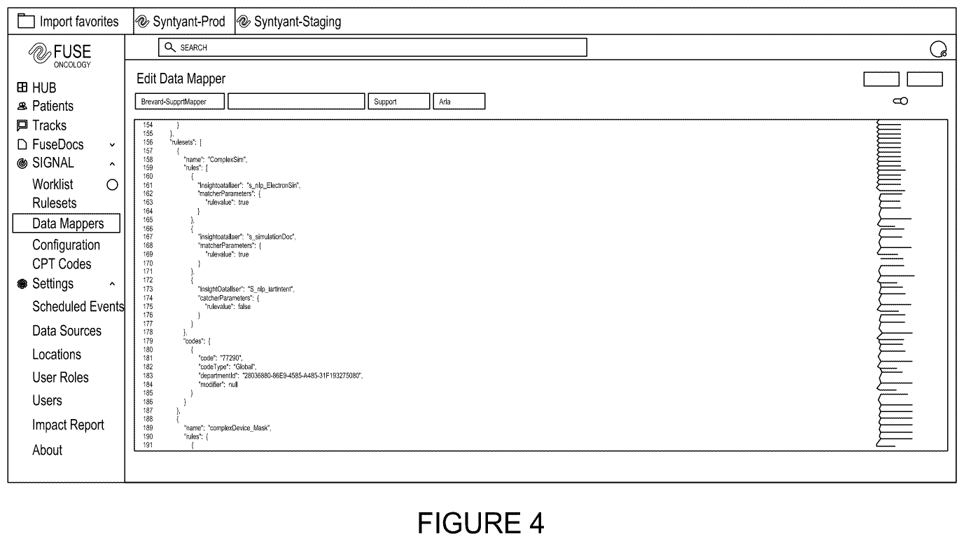

FIG. 4 illustrates a graphical user interface screen of the charge capture system showing an example of a configurable ruleset used to map detected clinical insights to billing charge codes. The interface is part of the cloud-hosted charge capture platform and is displayed within a web browser. On the left-hand portion of the screen, a navigation menu provides access to system modules, including HUB, Patients, Tracks, FusDocs, SIGNAL, Worklist, Rulesets, Data Mappers, Configuration, CPT Codes, Settings, and other administrative functions. In FIG. 4, the “Rulesets” menu item is selected, indicating that the screen is being used to edit or create a ruleset.

The main pane of the screen shows an editable ruleset named “SupportRule-Palm Bay” associated with a specific department and data capture type. The ruleset editor allows an administrator or user to specify logical rules that connect observed clinical insights to specific charge codes. The ruleset comprises one or more named rulesets, each with a set of rules and associated codes.

Within the example shown, a ruleset named “ComplexSim” contains a list of rules, where each rule specifies an insight data name and corresponding matcher parameters. The insight data name refers to a named clinical insight that has been detected elsewhere in the system, such as “S_nlp_ElectronSim,” “S_simulationDoc,” or “S_nlp_ImrtIntent.” These names correspond to specific insights derived from natural language processing of documentation, simulation events, or clinical intent data. The matcher parameters define the expected value for the insight, labeled “ruleValue,” which in the examples shown can be either true or false.

The ruleset editor allows defining multiple rules that evaluate insight data against specific expected values, forming logical conditions that determine whether a given set of insights meets the criteria for a billing charge. When all the conditions defined in the ruleset are satisfied, the system associates one or more billing codes with the event.

Below the rules section, the interface displays the codes section, which lists the billing codes to be applied when the ruleset conditions are met. In the illustrated example, a code “77290” is specified, with attributes such as code type, department identifier, and an optional modifier. These codes are typically standardized procedure or billing codes, such as CPT or HCPCS, that correspond to the services delivered.

The editor interface also includes controls to add or edit custom rule violations, save the ruleset, and validate the syntax and logic of the rules. A validation indicator appears on the upper right, confirming that the ruleset as currently written is valid.

This demonstrates how the system provides a flexible, user-configurable interface for defining the logical association between clinical insights and billing codes through a structured ruleset. The ruleset forms an integral part of the rules-based decision engine, which applies these configurations during automated charge capture to ensure that billing codes are assigned only when specific, validated clinical conditions are met. This mechanism allows organizations to adapt charge capture logic to their clinical workflows and payer requirements without modifying the underlying software

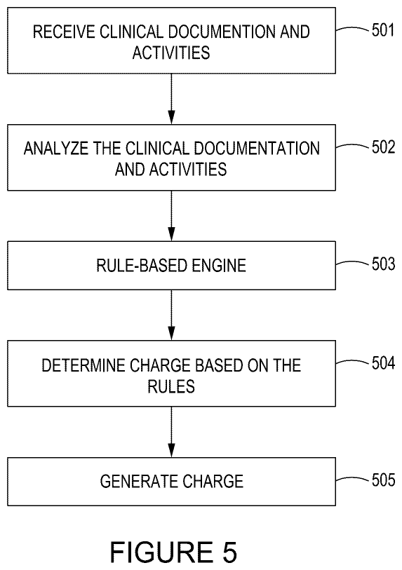

FIG. 5 illustrates a flowchart depicting an exemplary process of automated charge capture performed by the disclosed system. The process begins at the top of the figure, where clinical documentation and activity data are received from one or more clinical information systems, step 501. This input may include both structured data, such as event logs and treatment schedules, and unstructured data, such as physician notes or narrative reports. The system interfaces with electronic health record systems or specialty databases to securely retrieve this information.

Once the clinical data is received, the next step 502 involves analyzing the clinical documentation and activities. At this stage, the system processes structured data directly and applies natural language processing techniques to unstructured data to extract semantically meaningful information about the clinical activities performed. This analysis produces a set of identified attributes and events that reflect the care provided to the patient.

Following analysis, the process proceeds to the rule-based engine step 503. Here, the system applies a predefined set of billing rules, which are configured to reflect clinical, payer, and site-specific requirements. The rule-based engine evaluates combinations of attributes and events, referred to as insights, to determine whether specific billing conditions are met. The engine applies logical operations, such as conjunctions, disjunctions, and negations, to ensure that the charge determination aligns with regulatory and contractual billing guidelines.

The next step 504 in the process is determining the appropriate charge based on the rules. In this step, the system compares the evaluated insights and rule conditions against a library of known billing codes, such as CPT or HCPCS codes, and selects the code or codes that best match the documented clinical activity. The determination is made only when the documentation fully supports the charge and meets all configured requirements.

After the charge is determined, the final step 505 is to generate the charge and prepare it for export to the billing system. At this stage, the validated billing code is stored along with its supporting metadata, including the clinical documentation and timestamps, and is formatted in accordance with payer-specific claim requirements. The charge is then transmitted securely to an external billing platform or written back to the clinical system as appropriate.

Throughout the process, the system may generate audit logs and alerts if inconsistencies or documentation gaps are detected, allowing administrative personnel to intervene when necessary. This flow of operations ensures that billing codes are derived automatically, accurately, and compliantly from clinical documentation, thereby reducing the need for manual intervention and improving the efficiency and reliability of charge capture in healthcare settings.

In conclusion, an automated system and method for medical billing charge capture is hereby disclosed.

What is claimed is:

1. A computer-implemented system for automated medical billing charge capture, comprising:
a data ingestion engine configured to interface with a clinical information system to extract clinical event data and clinical documentation;
a natural language processor (NLP) coupled to the data ingestion engine configured to parse the clinical documentation to identify one or more clinical attributes;
a rule based engine coupled to the NLP comprising a plurality of executable billing rules and corresponding insight conditions, configured to receive the clinical attributes and clinical event data as input and automatically identify one or more billing codes;
a charge export module coupled to the rule based engine configured to transmit the billing codes to an external billing system via a secure protocol.

2. The system of claim 1 further comprising a charge validation subsystem configured to verify the billing codes based on documentation completeness and compliance parameters.

3. The system of claim 1, wherein the data ingestion engine includes an interface configured to parse HL7, FHIR, and DICOM data formats.

4. The system of claim 1, wherein the NLP receives unstructured text from clinical documentation, parses the text and applies algorithms to identify key information.

5. The system of claim 1, wherein the rule based engine includes a rules editor interface.

6. The system of claim 1, wherein the rules based engine comprises at least one gold carding rule set validated by a payer to bypass prior authorization.

7. The system of claim 1, wherein the validation subsystem generates a metadata log linking billing codes to corresponding supporting documentation and timestamp.

8. The system of claim 1, further comprising a compliance dashboard configured to display audit summaries and revenue performance metrics.

9. The system of claim 1, wherein the rule based decision engine is updated via machine learning models trained on historical billing discrepancies.

10. The system of claim 1, wherein the system identifies CPT codes and recommends code optimizations.

11. A non-transitory computer-readable medium storing instructions that, when executed by one or more processors, cause a system to perform steps comprising:
retrieving clinical data from a plurality of sources including structured events and unstructured documents;
analyzing the unstructured documents using a natural language processing engine to extract semantically relevant medical information;
generating a set of logical insights based on a mapping configuration for a clinical site; applying a rule engine to determine one or more charge codes by evaluating the insights against billing logic;
automatically submitting the determined charge codes to a billing interface for reimbursement processing.

12. The non-transitory computer-readable medium of claim 11, wherein the instructions further comprise generating an audit report summarizing missed charges, flagged inconsistencies, and compliance metrics.

13. The non-transitory computer-readable medium of claim 11, wherein the instructions further cause the system to rank documents by relevance prior to processing.

14. The non-transitory computer-readable medium of claim 10, wherein the instructions further comprise sending real-time notifications to clinical staff when documentation is insufficient to justify predicted charges.

15. A computer-implemented method for automated medical charge capture, comprising:
receiving structured and unstructured clinical data from a healthcare provider system;
detecting, via rule-based logic and machine-readable configuration data, an event triggering a mapping process;
generating one or more insights from the mapping process by processing the clinical data for compliance characteristics;
evaluating the insights using a rules engine to determine whether predetermined combinations of insight conditions are satisfied; predicting a medical billing code based on said evaluation;
validating and automatically transmitting the predicted code to a billing processor.

16. The method of claim 15, wherein the mapping process is triggered by the presence of an approved clinical document having a predefined document type.

17. The method of claim 15, wherein the insights comprise boolean flags derived from clinical event attributes comprising treatment date, modality, and document approval status.

18. The method of claim 15, further comprising storing the predicted billing code in a summary database for audit retrieval.

19. The method of claim 15, wherein the clinical data is filtered by site-specific configuration parameters before mapping execution.

20. The method of claim 15, wherein the transmitting step includes formatting the billing code into a claim object compliant with payer-specific schema.

21. The method of claim 15 further comprising payer verified rule sets, which allows bypassing prior authorization requirements if coding compliance is pre-validated.

22. A computer-implemented system for automated medical billing charge capture, comprising:
a client device configured to transmit authentication credentials and clinical event data from a customer network to a cloud-hosted charge capture platform;
a cloud-hosted charge capture platform comprising a hub virtual network and an application virtual network within a cloud service provider subscription, wherein the hub virtual network includes a virtual network gateway configured to establish a secure tunnel connection with the customer network and assign internal routing addresses;
a container orchestration platform hosted within the application virtual network, wherein the container orchestration platform manages a plurality of containers executing microservices configured to:
receive the clinical event data;
detect at least one clinical insight from the clinical event data by applying a predefined data mapper configuration specifying at least one insight context and an associated trigger condition;
evaluate the trigger condition against the clinical insight; and
generate a billing charge when the trigger condition is satisfied;
wherein the cloud-hosted charge capture platform further comprises a plurality of private endpoints configured to securely store the clinical event data, the clinical insights, and the billing charges in respective cloud storage services.

23. The system of claim 22, wherein the container orchestration platform includes a container configured to retrieve configuration rules from a key vault via a private endpoint and to execute the rules as defined in a data mapper editor.

24. The system of claim 22, wherein the private endpoints include a cloud-based SQL Server private endpoint connected to a signal web database configured to persist validated charge records.

25. The system of claim 22, wherein the data mapper configuration comprises a JSON document defining, for each rule, an insight context, a function, and one or more parameter values to be evaluated.

26. The system of claim 22, wherein the insight context is selected from the group consisting of: local, insight data, and constant.

27. The system of claim 22, wherein the container orchestration platform exposes an internal API through a private endpoint, enabling authenticated programmatic interaction with the charge capture microservices.

28. The system of claim 22, wherein the billing charge is transmitted securely to an external billing system after validation of documentation completeness and compliance parameters.

29. The system of claim 22 further comprising payer verified rule sets, which allows bypassing prior authorization requirements if coding compliance is pre-validated
